(19) United States
(12) Patent Application Publication
(10) Pub. No.: US 2026/0109013 A1
(43) Pub. Date: Apr. 23, 2026

(54) POWER TOOL AND OPERATION METHOD OF THE SAME

(71) Applicant: BASSO INDUSTRY CORP., Taichung (TW)

(72) Inventors: Tsung-Han WU, Taichung (TW); Min-Hsu TSAI, Taichung (TW)

(21) Appl. No.: 19/365,386

(22) Filed: Oct. 22, 2025

(30) Foreign Application Priority Data
Oct. 23, 2024 (TW) 113211485

(51) Int. Cl. B25F 5/00; B25F 5/02; H02P 23/20

(52) U.S. Cl. CPC B25F 5/001; B25F 5/02; H02P 23/20

(57) ABSTRACT

A power tool includes a trigger module, a motor unit, and a controller electrically connected to the trigger module and the motor unit. The controller stores parameter data that define a common control curve that represents a corresponding relationship between a reference pressed depth and a reference rotation speed. The controller obtains a pressing value from the trigger module, and outputs a control signal at least based on the common control curve and the pressing value to the motor unit. The common control curve has a low-speed curve segment and a high-speed curve segment. In a low speed mode, the controller outputs the control signal based on the low-speed curve segment. In a high speed mode, the controller outputs the control signal based on a high-speed control curve composed at least of the low-speed curve segment and the high-speed curve segment.

### CROSS-REFERENCE TO RELATED APPLICATION

This application claims priority to Taiwanese Utility Model Patent Application No. 113211485, filed on October 23, 2024, the entire disclosure of which is incorporated by reference herein.

### FIELD

The disclosure relates to a power tool and an operation method of the power tool.

### BACKGROUND

Referring to FIG. 1, a conventional method of controlling a rotation speed of a motor of a conventional power tool involves determining a pressed depth of a trigger of the conventional power tool and referring the pressed depth as one of a plurality of control curves 11-14 pre-stored in the conventional power tool. The control curves 11-14 correspond respectively to a plurality of operating modes (e.g., a maximum speed mode, a high speed mode, a medium speed mode, and a low speed mode), and each of the control curves 11-14 represents a corresponding relationship between the pressed depth of the trigger and a duty ratio of a pulse width modulation (PWM) control signal. The controller selects one of the control curves 11-14 based on one of the operating modes selected by a user, and outputs the PWM control signal based on the one of the control curves 11-14 thus selected. For example, when the user selects the high speed mode, the controller selects the control curve 12 that corresponds to the high speed mode, and outputs the PWM control signal based on a pressing value related to the pressed depth of the trigger of the conventional power tool and the control curve 12 thus selected.

However, when the trigger is pressed lightly by the user, the pressing force may not be precisely controlled. As a result, it is difficult for the user to accurately control the pressed depth of the trigger, which may easily cause the rotation speed of the motor to be higher than expected. Furthermore, during the development stage of the conventional power tool, engineers are required to prepare and simulate (or test) each of the control curves 11-14, which incur considerable time and cost.

### SUMMARY

Therefore, an object of the disclosure is to provide a power tool and an operation method of a power tool that can alleviate at least one of the drawbacks of the prior art.

According to an aspect of the disclosure, the power tool includes a housing unit, a motor unit, and a controller. The housing unit includes a housing, a trigger module that is disposed on the housing, and that includes a trigger and a trigger detection circuit, and a setting module that is disposed on the housing. The trigger detection circuit is configured to detect a pressed depth to which the trigger is being pressed and to output a trigger signal related to the pressed depth. The setting module is operable to switch the power tool among a plurality of operating modes that at least include a low speed mode and a high speed mode. The motor unit is disposed in the housing, and includes a motor. The controller is electrically connected to the trigger module and the motor unit. The controller stores parameter data that define a common control curve. The common control curve represents a corresponding relationship between a reference pressed depth and a reference rotation speed. The controller is configured to receive the trigger signal from the trigger detection circuit, to obtain a pressing value related to the pressed depth based on the trigger signal, and to output a control signal at least based on the common control curve and the pressing value to the motor unit for controlling a rotation speed of the motor. The common control curve has a low-speed curve segment that corresponds to the reference pressed depth ranging from zero to a first value and to the reference rotation speed ranging from zero to a predetermined low speed, and a high-speed curve segment that corresponds to the reference pressed depth greater than the first value and to the reference rotation speed greater than the predetermined low speed. The reference rotation speed is positively correlated to the reference pressed depth in each of the low-speed curve segment and the high-speed curve segment. Each of the low-speed curve segment and the high-speed curve segment has a slope that increases with an increase in the reference pressed depth. In the low speed mode, the controller is configured to, in response to obtaining the pressing value not greater than the first value, output the control signal to control the rotation speed of the motor based on the low-speed curve segment of the common control curve, and in response to obtaining the pressing value greater than the first value, output the control signal to control the rotation speed of the motor to be not greater than the predetermined low speed. In the high speed mode, the controller is configured to output the control signal to control the rotation speed of the motor based on a high-speed control curve composed at least of the low-speed curve segment and the high-speed curve segment.

According to another aspect of the disclosure, the operation method of the power tool as mentioned above includes: in the low speed mode, in response to obtaining the pressing value not greater than the first value, the controller controlling the rotation speed of the motor based on the low-speed curve segment of the common control curve, and in response to obtaining the pressing value greater than the first value, the controller controlling the rotation speed of the motor to be not greater than the predetermined low speed; and in the high speed mode, the controller controlling the rotation speed of the motor based on the high-speed control curve composed at least of the low-speed curve segment and the high-speed curve segment.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a diagram illustrating conventional control curves used for controlling a conventional power tool.

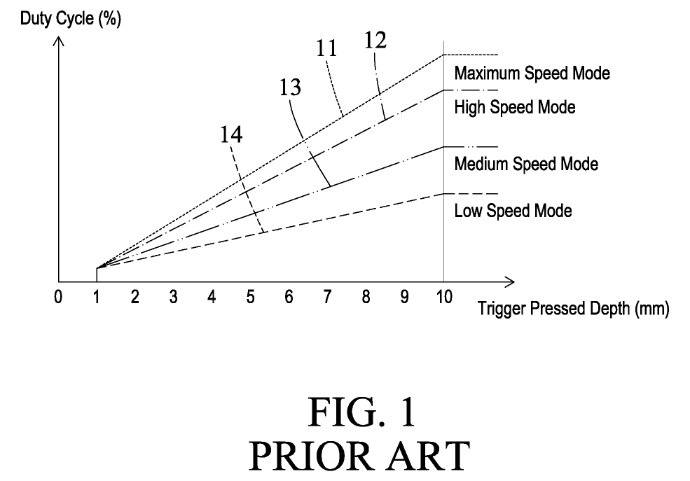

FIG. 2 is a perspective view of a first embodiment of a power tool according to the present disclosure.

FIG. 3 is a block diagram illustrating the power tool according to an embodiment of the present disclosure.

FIG. 4 is a diagram illustrating an example of a common control curve used for controlling the power tool according to an embodiment of the present disclosure.

FIG. 5 is a perspective view illustrating a second embodiment of the power tool according to the present disclosure.

FIG. 6 is a partial sectional view of the second embodiment of the power tool of the present disclosure illustrating a setting module being connected to a sliding ring gear via a shift arm.

FIG. 7 is a cross sectional view illustrating an abutment element in a limiting position and the sliding ring gear in a rotatable position according to the second embodiment of the power tool of the present disclosure.

FIG. 8 is a cross sectional view illustrating the abutment element in a non-limiting position and the sliding ring gear in a fixed position according to the second embodiment of the power tool of the present disclosure.

FIG. 9 is a diagram illustrating another example of the common control curve used for controlling the power tool according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

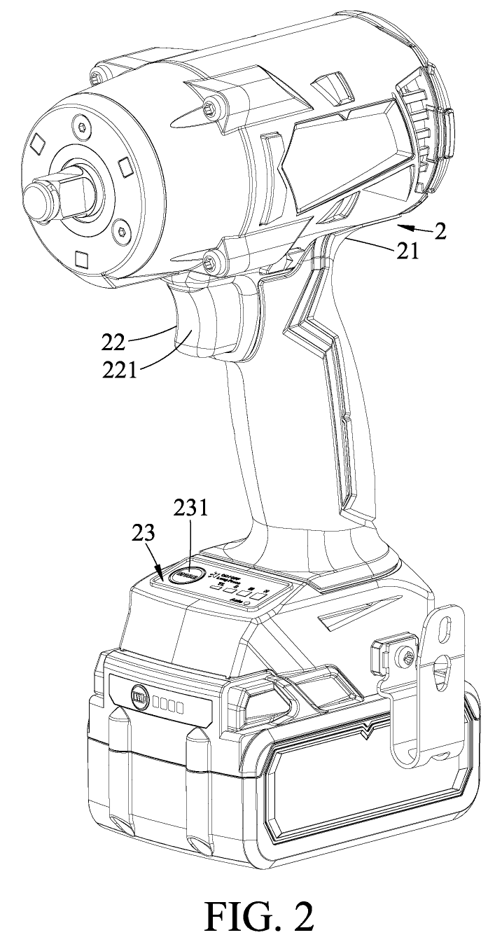

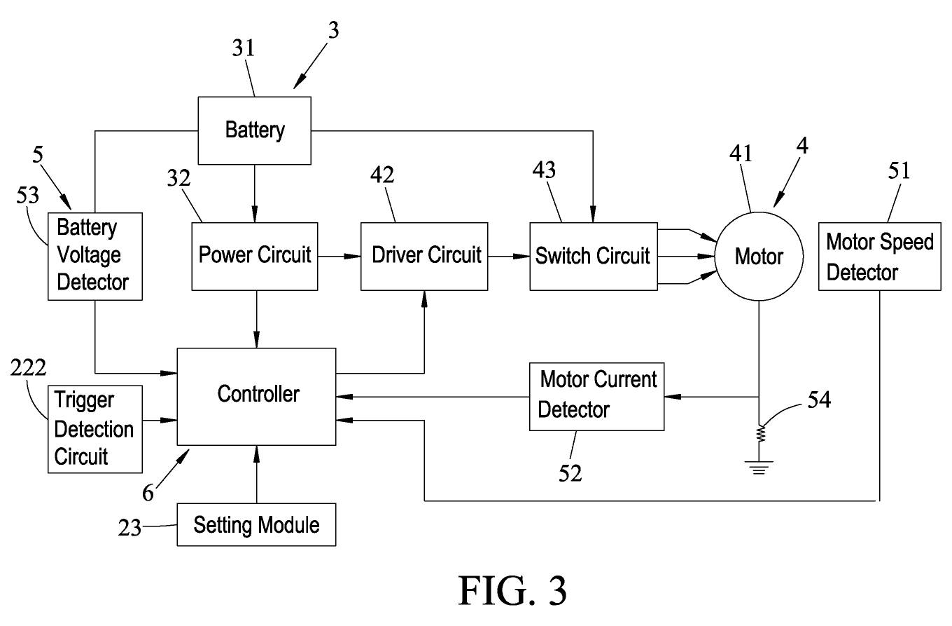

Referring to FIGS. 2 and 3, a first embodiment of a power tool according to the present disclosure includes a housing unit 2, a power supply unit 3, a motor unit 4, a detection unit 5, and a controller 6.

The housing unit 2 includes a housing 21, a trigger module 22, and a setting module 23.

The trigger module 22 is disposed on the housing 21, and includes a trigger 221 that is disposed on the housing 21, and a trigger detection circuit 222 that is electrically connected to the controller 6. The trigger detection circuit 222 is configured to detect a pressed depth to which the trigger 221 is being pressed, and to output a trigger signal related to the pressed depth. In one embodiment, the trigger detection circuit 222 is exemplified as a circuit that includes a variable resistor such as a potentiometer (not shown) and the trigger signal is in a form of a voltage signal, but the disclosure is not limited to such. Specifically, when a user presses the trigger 221, a resistance of the variable resistor changes, which is detected by the controller 6. The controller 6 then obtains a pressing value that is related to the pressed depth based on the trigger signal. Specifically, the pressing value is a voltage value of the trigger signal that is proportional to the pressed depth of the trigger 221, and therefore, the pressing value may be used to represent the pressed depth.

The setting module 23 is disposed on the housing 21 and is operable to switch the power tool among a plurality of operating modes. In the first embodiment of the power tool of this disclosure, the operating modes include a low speed mode, a medium speed mode, and a high speed mode. In one embodiment, the setting module 23 outputs a setting signal indicating one of the operating modes based on user operation. The setting module 23 may be exemplified using a button 231 as shown in FIG. 2 that allows the user to perform operations thereon. In other embodiments, the setting module 23 may be exemplified by a touch panel, and is not limited thereto.

The power supply unit 3 includes a battery 31 disposed in the housing 21, and a power circuit 32 electrically connected to the battery 31. The power circuit 32 is configured to stabilize and adjust a voltage of power supplied by the battery 31, and to supply the power thus stabilized and adjusted to internal circuits of the power tool. In one embodiment, the power circuit 32 may include, for example, a low-dropout (LDO) regulator (not shown) for stabilizing the power supplied by the battery 31, but the disclosure is not limited in this respect.

The motor unit 4 includes a motor 41 disposed in the housing 21, a driver circuit 42 electrically connected to the controller 6, and a switch circuit 43 electrically connected to the motor 41 and the driver circuit 42. In one embodiment, the motor 41 is exemplified as a brushless direct current (BLDC) motor, but the disclosure is not limited to such. The driver circuit 42 is configured to receive a control signal in a form of a pulse width modulation (PWM) signal from the controller 6, and to control the switch circuit 43 to drive the motor 41 to rotate according to a duty ratio of the PWM signal (i.e., the control signal) thus received. In one embodiment, the switch circuit 43 is implemented using one or more metal-oxide-semiconductor field-effect transistors (MOSFETs), but is not limited to such.

The detection unit 5 includes a motor speed detector 51, a motor current detector 52, a battery voltage detector 53 and a sensing resistor 54.

The motor speed detector 51 is disposed in correspondence to the motor 41, and is configured to detect a rotor of the motor 41 so as to output relevant information such as a position of the rotor that may represent a rotation speed of the motor 41 to the controller 6. In one embodiment, the motor speed detector 51 is exemplified as a Hall sensor, but the disclosure is not limited in this respect.

The motor current detector 52 cooperates with the sensing resistor 54 to detect an electric current of the motor 41, and outputs a current signal indicating a current value of the electric current of the motor 41 to the controller 6 for the controller 6 to monitor the electric current of the motor 41. For example, when the electric current of the motor 41 exceeds a predetermined current value that may be set by the user, the controller 6 controls the driver circuit 42 to stop the motor 41 from operating, thereby achieving an over-current protection. In one embodiment, the motor current detector 52 may be exemplified as a differential amplifier circuit that includes a differential amplifier or an operational amplifier (op-amp) connected across the sensing resistor 54 to measure a voltage drop across the sensing resistor 54, but the disclosure is not limited in this respect.

The battery voltage detector 53 is electrically connected between the battery 31 and the controller 6. The battery voltage detector 53 is configured to detect a voltage value of the battery 31, and to output the voltage value thus detected to the controller 6 for the controller 6 to monitor the voltage of the battery 31. In one embodiment, the battery voltage detector 53 may be implemented by a comparator circuit or a dedicated battery monitoring integrated circuit, but the disclosure is not limited in this respect.

The controller 6 is electrically connected to the trigger detection circuit 222, the setting module 23, the power circuit 32, the motor unit 4, and the detection unit 5. The controller 6 may be exemplified as an integrated circuit that is capable of, for example, analog-to-digital (A/D) conversion, input/output (I/O) detection, PWM signal generation, computational capabilities, etc. In one embodiment, the controller 6 is exemplified as a microcontroller unit (MCU), although the disclosure is not limited thereto.

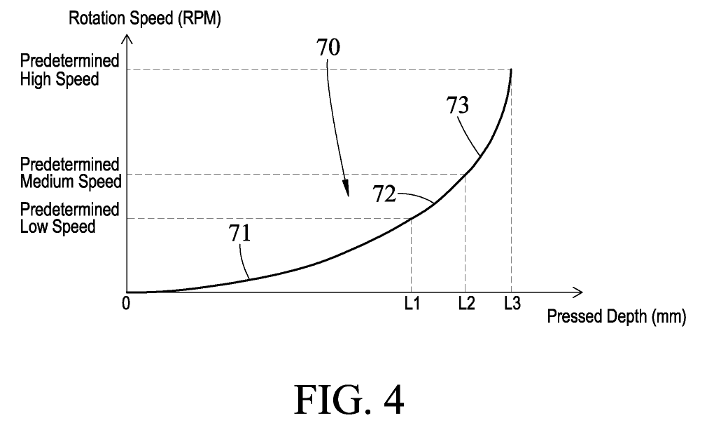

Further referring to FIG. 4, the controller 6 stores parameter data that define a common control curve 70 that is for controlling the rotation speed of the motor 41 and that represents a corresponding relationship between a reference pressed depth and a reference rotation speed. FIG. 4 shows a first example of the common control curve 70 that has a low-speed curve segment 71, a medium-speed curve segment 72, and a high-speed curve segment 73. Specifically, in a first example of the common control curve 70 shown in FIG. 4, the low-speed curve segment 71 corresponds to the reference pressed depth ranging from zero to a first value (L1) and to the reference rotation speed ranging from zero to a predetermined low speed, the medium-speed curve segment 72 corresponds to the reference pressed depth ranging from the first value (L1) to a second value (L2) that is greater than the first value (L1) and to the reference rotation speed ranging from the predetermined low speed to a predetermined medium speed that is greater than the predetermined low speed, and the high-speed curve segment 73 corresponds to the reference pressed depth ranging from the second value (L2) to a third value (L3) that is greater than the second value (L2) and to the reference rotation speed greater than the predetermined medium speed and not greater than a predetermined high speed. The predetermined high speed is greater than the predetermined medium speed. In the first example of the common control curve 70, the reference rotation speed is positively correlated to the reference pressed depth in each of the low-speed curve segment 71, the medium-speed curve segment 72 and the high-speed curve segment 73. The first example of the common control curve 70 is defined by an exponential function. That is to say, each of the low-speed curve segment 71, the medium-speed curve segment 72 and the high-speed curve segment 73 has a slope that increases with an increase in the reference pressed depth. By virtue of the abovementioned arrangements, as the reference pressed depth increases, the reference rotation speed slowly increases at first and subsequently accelerates.

The controller 6 is configured to obtain the pressing value, to receive the setting signal from the setting module 23, and to output the control signal based on the common control curve 70, one of the operating modes indicated by the setting signal thus received and the pressing value to the motor unit 4 for controlling the rotation speed of the motor 41.

An operation method of the first embodiment of the power tool using the first embodiment of the common control curve 70 is illustrated in the following paragraphs.

In the low speed mode, the controller 6, in response to obtaining the pressing value not greater than the first value (L1), outputs the control signal to control the rotation speed of the motor based on the low-speed curve segment 71 of the common control curve 70, and in response to obtaining the pressing value greater than the first value (L1), outputs the control signal to control rotation speed of the motor 41 to be not greater than the predetermined low speed. For example, when the controller 6 obtains the pressing value that is not greater than the first value (L1), the controller 6 controls the rotation speed of the motor 41 to be a value of the reference rotation speed in the low-speed curve segment 71 that corresponds to a value of the reference pressed depth that corresponds to the pressing value thus obtained. When the controller 6 obtains the pressing value that is greater than the first value (L1), the controller 6 controls the rotation speed of the motor 41 to be at the predetermined low speed.

In the medium speed mode, the controller 6, in response to obtaining the pressing value not greater than the second value (L2), outputs the control signal to control the rotation speed of the motor 41 based on a medium-speed control curve that is composed of the low-speed curve segment 71 and the medium-speed curve segment 72, and in response to obtaining the pressing value greater than the second value, outputs the control signal to control the rotation speed of the motor 41 to be not greater than the predetermined medium speed. For example, when the controller 6 obtains the pressing value that is not greater than the second value (L2), the controller 6 controls the rotation speed of the motor 41 to be a value of the reference rotation speed in the medium-speed control curve that corresponds to a value of the reference pressed depth that corresponds to the pressing value thus obtained. When the controller 6 obtains the pressing value that is greater than the second value (L2), the controller 6 controls the rotation speed of the motor 41 to be at the predetermined medium speed.

In the high speed mode, the controller 6, in response to obtaining the pressing value not greater than a third value (L3), outputs the control signal to control the rotation speed of the motor 41 based on a high-speed control curve composed of the low-speed curve segment 71, the medium-speed curve segment 72, and the high-speed curve segment 73 that are connected to each other in such sequence. The high-speed control curve is identical to the common control curve 70. That is to say, the high-speed control curve is defined by the same exponential function as the common control curve 70. Furthermore, the controller 6, in response to obtaining the pressing value greater than the third value (L3), outputs the control signal to control the rotation speed of the motor 41 to be not greater than the predetermined high speed. For example, when the controller 6 obtains the pressing value that is not greater than the third value (L3), the controller 6 controls the rotation speed of the motor 41 to be a value of the reference rotation speed in the high-speed control curve that corresponds to a value of the reference pressed depth that corresponds to the pressing value thus obtained. When the controller 6 obtains the pressing value that is greater than the third value (L3), the controller 6 controls the rotation speed of the motor 41 to be at the predetermined high speed. The predetermined high speed may be a rated speed of the motor 41, but is not limited to such.

In a case where the power tool only has a low-speed mode and a high-speed mode, a common control curve for this power tool only has a low-speed curve segment and a high-speed curve segment, and the controller 6 controls the rotation speed of the motor 41 based on the low-speed curve segment in the low-speed mode, and controls the rotation speed of the motor 41 based on a high-speed control curve composed of the low-speed curve segment and the high-speed curve segment in the high-speed mode.

In some embodiments, the controller 6 stores a function that maps an input to a rotation speed output, and in response to obtaining the pressing value, uses the pressing value as the input of the function so as to obtain the rotation speed output that corresponds to the pressing value, and then controls the rotation speed of the motor 41 based on the rotation speed output. In some embodiments, the controller 6 stores multiple functions respectively for the operating modes. It should be noted that using the function(s) to control the rotation speed of the motors can achieve the same effect as the common control curve.

By virtue of the abovementioned arrangements, the controller 6 is able to control the rotation speed of the motor 41 in the low speed mode, the medium speed mode and the high speed mode by using the same control curve (i.e., the common control curve 70). Specifically, the controller 6 controls the rotation speed of the motor 41 based on the low-speed curve segment 71, the medium-speed control curve, and the high-speed control curve that correspond respectively to the low speed mode, the medium speed mode, and the high speed mode.

Through the above description, the advantages of the first embodiment of the power tool using the first example of the common control curve 70 are summarized in the following paragraphs.

The reference rotation speed is positively correlated to the reference pressed depth in each of the low-speed curve segment 71, the medium-speed curve segment 72, and the high-speed curve segment 73 of the common control curve 70. Each of the low-speed curve segment 71, the medium-speed curve segment 72, and the high-speed curve segment 73 has the slope that increases with the increase in the reference pressed depth. Accordingly, the rotation speed of the motor 41 is controlled to slowly increases when the trigger 221 is pressed to a relatively small depth (i.e., a small pressed depth), and subsequently increases at an accelerated rate as the pressed depth increases. That is to say, even in the high speed mode, when the pressing value is relatively small (e.g., not greater than the first value (L1)), the rotation speed of the motor 41 increases relatively slowly, and the rotation speed of the motor 41 undergoes an accelerated increase as the pressing value obtained increases. By virtue of the abovementioned arrangement, when the trigger 221 is pressed lightly by the user, even if it is difficult for the user to maintain a stable pressing force on the trigger 221, the rotation speed of the motor 41 may not change greatly and exceed the user’s expectations. As the user increases the pressing force that results in a greater pressed depth of the trigger 221, the rotation speed of the motor 41 may increase at an accelerated rate and achieve a maximum speed of the operating mode (i.e., the predetermined low speed for the low-speed mode, the predetermined medium speed for the medium-speed mode, or the predetermined high speed for the high-speed mode).

Furthermore, the controller 6 controls the rotation speed of the motor 41 based on the common control curve 70 for all of the operating modes, such that the time and the cost that are required for writing control codes and conducting simulations (or testing) during the research and development phase of the power tool may be reduced.

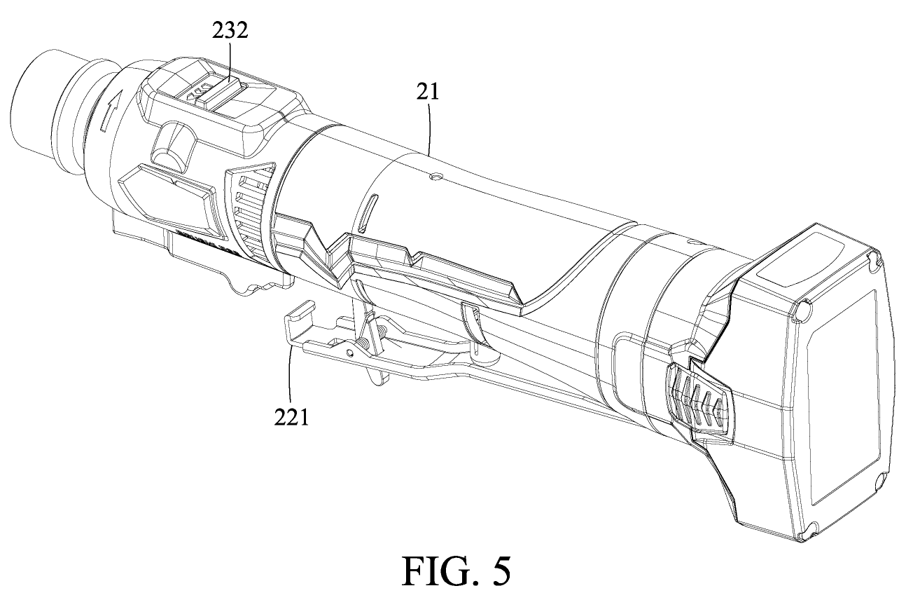

Referring to FIGS. 3, 5, 6 and 7, a second embodiment of the power tool according to the present disclosure is similar to the first embodiment of the power tool, and only aspects of the second embodiment of the power tool that are different from the first embodiment of the power tool will be described in the following for the sake of brevity.

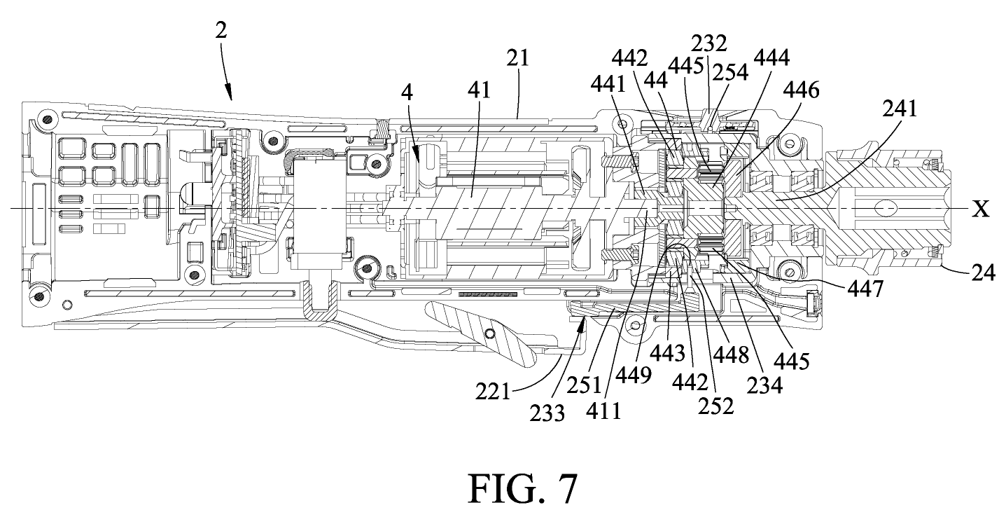

In the second embodiment of the power tool, the housing unit 2 extends along an X-axis, and further includes a chuck 24 rotatably disposed on one end (i.e., the right side with respect to FIG. 7) of the housing 21 along the X-axis. The chuck 24 includes a chuck arbor 241 that extends from the chuck 24 toward the motor unit 4 inside the housing 21 along the X-axis.

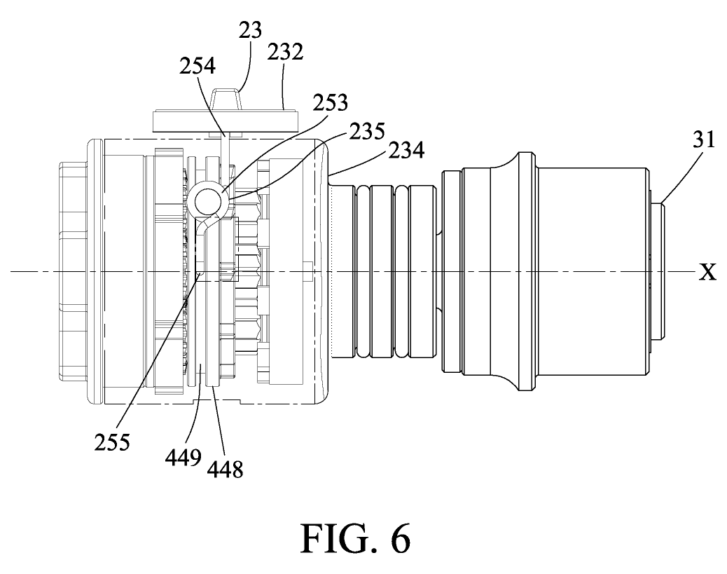

Referring to FIGS. 6, 7, and 8, the setting module 23 further includes a slider element 232 disposed on the housing 21, an abutment element 233 disposed on the housing 21 in correspondence to the trigger 221, a ring seat 234 disposed in the housing 21, and a shift arm 235 disposed in the ring seat 234. For the sake of clarity, in FIG. 6, part of the ring seat 234 is drawn with imaginary lines to reveal internal structures of the ring seat 234.

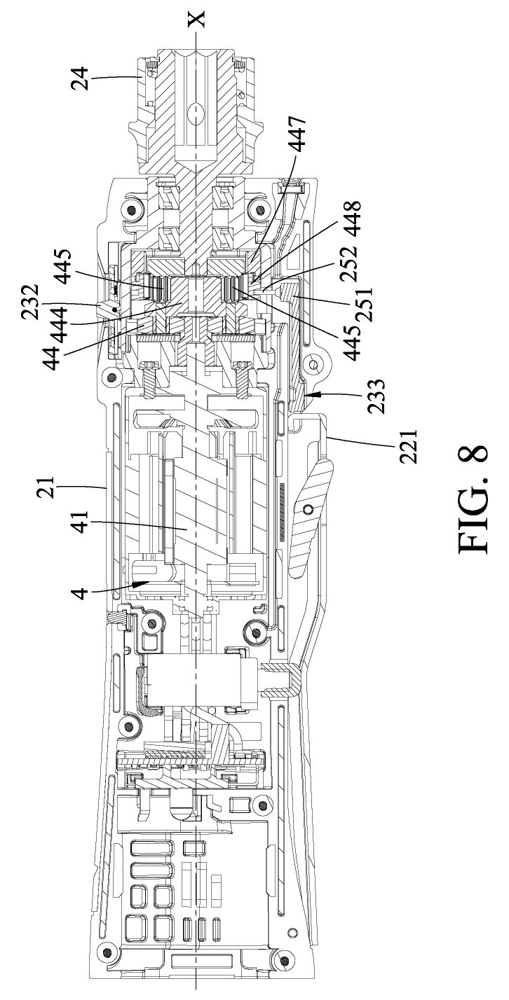

The slider element 232 is operable by the user to mechanically switch the operating modes. In the second embodiment of the power tool, when the slider element 232 is operated by the user to slide to one side proximate to the chuck 24 as shown in FIG. 7, the power tool operates in the low speed mode. When the slider element 232 is operated by the user to slide to another side distal from the chuck 24 as shown in FIG. 8, the power tool operates in the high speed mode. It should be noted that, in the second embodiment of the power tool, the operating modes only include the low speed mode and the high speed mode, but the disclosure is not limited in this respect.

The abutment element 233 includes a body 251 having a connecting end distal from the trigger 221, and an abutting end opposite to the connecting end and proximate to the trigger 221. The abutment element 233 further includes a linkage portion 252 that extends inwardly with respect to the housing 21 of the power tool from the connecting end of the body 251 in a direction parallel to a radial line (not shown) substantially perpendicular to the X-axis. The abutment element 233 is driven to move by the slider element 232 along the X-axis to be in a limiting position where the abutting end of the body 251 allows the trigger 221 to be pressed to a first pressed depth as shown in FIG. 7, or a non-limiting position where the abutting end of the body 251 allows the trigger 221 to be pressed to a second pressed depth that is greater than the first pressed depth as shown in FIG. 8. In the second embodiment of the power tool, the limiting position corresponds to the low speed mode, and the non-limiting position corresponds to the high speed mode.

Referring to FIG. 7, when the abutment element 233 is at the limiting position, the trigger 221 abuts against the abutting end of the body 251 when pressed to the first pressed depth. A distance of the trigger 221 from a position where the trigger 221 is not pressed, to another position where the trigger 221 is pressed to the first pressed depth corresponds to a first pressing stroke. Referring to FIG. 8, when the abutment element 233 is at the non-limiting position, the trigger 221 does not abut against the abutting end of the body 251 but abuts against the housing 21 when being pressed to the second pressed depth. A distance of the trigger 221 from the position where the trigger 221 is not pressed, to another position where the trigger 221 is pressed to the second pressed depth corresponds to a second pressing stroke.

Referring to FIGS. 6, 7 and 8, the ring seat 234 is disposed in the housing 21 and surrounds the X-axis. The shift arm 235 includes a pivot portion 253 disposed on the ring seat 234, a first end 254 connected to the slider element 232, and a second end 255 opposite to the first end 254.

The motor 41 includes a motor shaft 411 that extends along the X-axis.

The motor unit 4 further includes a gearbox 44 that is connected to the motor shaft 411 of the motor 41, and that is configured to transmit a rotational power from the motor 41 at different gear ratios, and to output the rotational power at different rotation speeds corresponding to the different gear ratios. The gearbox 44 switches to output the rotational power at the different rotational speeds (i.e., at different gear ratios) based on a position of the slider element 232.

The gearbox 44 includes a first sun gear 441 sleeved on the motor shaft 411 and co-rotatable with the motor shaft 411, a plurality of first planet gears 442 radially disposed around the X-axis and meshing with the first sun gear 441, a stationary ring gear 443 non-rotatably disposed to surround the X-axis, and surrounding and meshing with the first planet gears 442, a second sun gear 444 rotatably connected to the first planet gears 442 and driven to rotate by the first planet gears 442, a plurality of second planet gears 445 radially disposed around and meshing with the second sun gear 444, a carrier 446 rotatably connected to the second planet gears 445 and driven to rotate by the second planet gears 445, a toothed ring gear 447 connected to the ring seat 234 and surrounding the carrier 446, and a sliding ring gear 448 surrounding the second planet gears 445 and movable along the X-axis. The carrier 446 engages with the chuck arbor 241, and drives the chuck arbor 241 to rotate. The sliding ring gear 448 is annular in shape, and has an annular groove 449 formed in an outer peripheral surface of the sliding ring gear 448 to allow the linkage portion 252 of the abutment element 233 and the second end 255 of the shift arm 235 to be disposed thereon.

The sliding ring gear 448 is movable relative to the second planet gears 445 along the X-axis between a rotatable position (see FIG. 7) and a fixed position (see FIG. 8). When the sliding ring gear 448 is in the rotatable position, the sliding ring gear 448 disengages from the toothed ring gear 447, and is driven by the second planet gears 445 to rotate together therewith. When the sliding ring gear 448 is in the fixed position, the sliding ring gear 448 meshes with the toothed ring gear 447 and is not rotatable, and the second planet gears 445 are rotatable relative to the sliding ring gear 448 about the second sun gear 444. By virtue of the abovementioned arrangements, the second embodiment of the power tool is able to switch between the operating modes, and the user may select the different gear ratios to allow the slider element 232 to move the switch arm 235 and subsequently move the sliding ring gear 448 between the rotatable position and the fixed position. Furthermore, by moving the sliding ring gear 448 between the rotatable position and the fixed position, the linkage portion 252 and the abutment element 233 are moved along with the sliding ring gear 448, which moves the abutment element 233 between the limiting position and the non-limiting position, thereby changing a pressable depth of the trigger 221 (a depth to which the trigger 221 may be pressed) between the first pressing stroke and the second pressing stroke.

Referring to FIGS. 7, 8 and 9, the abutment element 233, when being in the limiting position, corresponds to the first pressing stroke of the trigger 221 and to the low speed mode, and when being in the non-limiting position, corresponds to the second pressing stroke of the trigger 221 and to the high speed mode. A maximum value of the pressed depth of the trigger 221 in the second pressing stroke is greater than a maximum value of the pressed depth of the trigger 221 in the first pressing stroke.

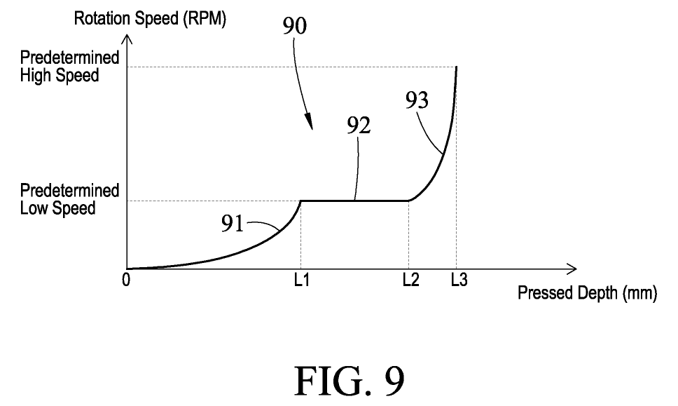

In the second embodiment, the controller 6 uses a second example of the common control curve 90 shown in FIG. 9 to control the rotation speed of the motor 41. In the second example of the common control curve 90, the common control curve 90 further has a low-speed curve segment 91, an intermediate segment 92 and a high-speed curve segment 93. The low-speed curve segment 91 corresponds to the reference pressed depth ranging from zero to a first value (L1) and to the reference rotation speed ranging from zero to a predetermined low speed. The intermediate segment 92 is between the low-speed curve segment 91 and the high-speed curve segment 93, and corresponds to the reference pressed depth ranging from the first value (L1) to a second value (L2) greater than the first value (L1) and to the reference rotation speed not greater than the predetermined low speed. Specifically, the intermediate segment 92 is defined by a constant function and corresponds to the reference rotation speed equal to the predetermined low speed. The high-speed curve segment 93 corresponds to the reference pressed depth ranging from the second value (L2) to a third value (L3) that is greater than the second value (L2) and to the reference rotation speed greater than the predetermined low speed and not greater than the predetermined high speed. The low-speed curve segment 91 is defined by a first exponential function that has a first fixed base, and the high-speed curve segment 93 is defined by a second exponential function that is different from the first exponential function and that has a second fixed base smaller than the first fixed base. By virtue of the aforementioned arrangement, a value of the reference pressed depth corresponding to the predetermined high speed on an extending curve of the low-speed curve segment 91 is less than a value of the reference pressed depth corresponding to the predetermined high speed on the high-speed curve segment 93. A range of the reference rotation speed from zero to the predetermined low speed on the low-speed curve segment 91 is smaller than a range of the reference rotation speed from the predetermined low speed to the predetermined high speed on the high-speed curve segment 93. A range of the reference pressed depth from zero to the first value (L1) on the low-speed curve segment 91 is greater than a range of the reference pressed depth from the second value (L2) to the third value (L3) on the high-speed curve segment 93. The first pressing stroke corresponds to the low-speed curve segment 91. That is to say, the pressable distance of the trigger 221 in the first pressing stroke ranges from zero to the first value (L1). The second pressing stroke corresponds to a high-speed control curve composed of the low-speed curve segment 91, the intermediate segment 92 and the high-speed curve segment 93 that are connected to each other in such sequence. That is to say, the pressable distance of the trigger 221 in the second pressing stroke ranges from zero to the third value (L3). Specifically, in the low speed mode, the trigger 221 is limited to the first pressing stroke (0 to L1), and the controller 6 controls the rotation speed of the motor 41 based on the low-speed curve segment 91 of the common control curve 90. In the high speed mode, the trigger 221 is limited to the second pressing stroke (0 to L3), and the controller 6 controls the rotation speed of the motor 41 based on the high-speed control curve.

Referring to FIGS. 3 and 9, in the low speed mode, the controller 6 outputs the control signal to control the rotation speed of the motor 41 to be not greater than the predetermined low speed based on the low-speed curve segment 91 of the second embodiment of the common control curve 90. In the high speed mode, the controller 6 outputs the control signal to control the rotation speed of the motor 41 to be not greater than the predetermined high speed based on the high-speed control curve that is composed of the low-speed curve segment 91, the intermediate segment 92, and the high-speed curve segment 93. Specifically, in the high speed mode, in response to obtaining the pressing value not greater than the third value (L3), the controller 6 outputs the control signal to control the rotation speed of the motor 41 based on the high-speed control curve. The high-speed control curve is identical to the common control curve 90.

Referring to FIGS. 3, 7 and 9, the second embodiment of the power tool has similar advantages compared to the first embodiment of the power tool. Using the second example of the common control curve 90, in the low speed mode that corresponds to the first pressing stroke (0 to L1), in response to the controller 6 obtaining the pressing value greater than the first value (L1), the controller 6 outputs the control signal to control the rotation speed of the motor 41 to be not greater than the predetermined low speed (specifically, at the predetermined low speed). By virtue of this arrangement, the second embodiment of the power tool may prevent a manufacturing error (e.g., an error in a thickness of the abutment element 233 during manufacturing may cause a variation in the first pressing stroke (0 to L1)) from affecting the rotation speed of the motor 41. For example, when a thickness of the body 251 of the abutment element 233 is less than a predetermined thickness and causes the trigger 221 to be pressed beyond the first pressing stroke (0 to L1), which causes the controller 6 to obtain the pressing value greater than the first value (L1), the controller 6 is still able to control the rotation speed of the motor 41 to be not greater than the predetermined low speed.

In addition, by virtue of the common control curve 90 including the intermediate segment 92, the user is able to feel the same operating experience in both of the low speed mode and the high speed mode when the user presses the trigger 221 to the first pressing stroke (0 to L1). Other than that, the intermediate segment 92 may provide a bigger range of pressed depth for the rotation speed to reach the predetermined high speed as compared to a control curve defined by an exponential function without an intermediate segment, such that the common control curve 90 has a variation of the reference rotation speed that slowly increases first and subsequently increases at an accelerated rate.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power tool comprising:
a housing unit including
a housing,
a trigger module disposed on said housing, including a trigger, and a trigger detection circuit configured to detect a pressed depth to which said trigger is being pressed and to output a trigger signal related to the pressed depth, and
a setting module disposed on said housing and operable to switch said power tool among a plurality of operating modes that at least include a low speed mode and a high speed mode;
a motor unit disposed in said housing and including a motor; and
a controller electrically connected to said trigger module and said motor unit, storing parameter data that define a common control curve that represents a corresponding relationship between a reference pressed depth and a reference rotation speed, and configured to receive the trigger signal from said trigger detection circuit, to obtain a pressing value related to the pressed depth based on the trigger signal, and to output a control signal at least based on the common control curve and the pressing value to said motor unit for controlling a rotation speed of said motor, the common control curve having a low-speed curve segment that corresponds to the reference pressed depth ranging from zero to a first value and to the reference rotation speed ranging from zero to a predetermined low speed, and a high-speed curve segment that corresponds to the reference pressed depth greater than the first value and to the reference rotation speed greater than the predetermined low speed, the reference rotation speed being positively correlated to the reference pressed depth in each of the low-speed curve segment and the high-speed curve segment, each of the low-speed curve segment and the high-speed curve segment having a slope that increases with an increase in the reference pressed depth,
wherein, in the low speed mode, said controller is configured to
in response to obtaining the pressing value not greater than the first value, output the control signal to control the rotation speed of said motor based on the low-speed curve segment of the common control curve, and
in response to obtaining the pressing value greater than the first value, output the control signal to control the rotation speed of said motor to be not greater than the predetermined low speed, and
wherein, in the high speed mode, said controller is configured to output the control signal to control the rotation speed of said motor based on a high-speed control curve composed at least of the low-speed curve segment and the high-speed curve segment.

2. The power tool as claimed in claim 1, wherein said setting module is configured to output a setting signal indicating one of the plurality of operating modes based on user operation, and said controller is further electrically connected to said setting module and further configured to receive the setting signal from said setting module, and to output the control signal based on one of the plurality of operating modes indicated by the setting signal thus received.

3. The power tool as claimed in claim 1, the plurality of operating modes further including a medium speed mode,
wherein the common control curve stored in said controller further has a medium-speed curve segment that corresponds to the reference pressed depth ranging from the first value to a second value greater than the first value and to the reference rotation speed ranging from the predetermined low speed to a predetermined medium speed, the reference rotation speed is positively correlated to the reference pressed depth on the medium-speed curve segment, and the medium-speed curve segment has a slope that increases with an increase in the reference pressed depth,
wherein, in the medium speed mode, said controller is configured to
in response to obtaining the pressing value not greater than the second value, output the control signal to control the rotation speed of said motor based on a medium-speed control curve composed of the low-speed curve segment and the medium-speed curve segment, and
in response to obtaining the pressing value greater than the second value, output the control signal to control the rotation speed of said motor to be not greater than the predetermined medium speed.

4. The power tool as claimed in claim 3, wherein the high-speed curve segment corresponds to the reference pressed depth greater than the second value and to the reference rotation speed greater than the predetermined medium speed,
wherein, in the high speed mode, said controller is configured to output the control signal to control the rotation speed of said motor based on the high-speed control curve composed of the low-speed curve segment, the medium-speed curve segment, and the high-speed curve segment.

5. The power tool as claimed in claim 1, wherein the high-speed curve segment corresponds to the reference rotation speed greater than the predetermined low speed and not greater than a predetermined high speed.

6. The power tool as claimed in claim 1, wherein the common control curve is defined by an exponential function and further has a medium-speed segment that corresponds to the reference pressed depth ranging from the first value to a second value greater than the first value and to the reference rotation speed ranging from the predetermined low speed to a predetermined medium speed, the high-speed curve segment corresponds to the reference pressed depth greater than the second value and to the reference rotation speed greater than the predetermined medium speed,
wherein, in the high speed mode, said controller is configured to output the control signal to control the rotation speed of said motor based on the high-speed control curve composed of the low-speed curve segment, the medium-speed curve segment, and the high-speed curve segment that are connected to each other in such sequence, and the high-speed control curve is identical to the common control curve.

7. The power tool as claimed in claim 1, wherein the low speed mode corresponds to a first pressing stroke of said trigger, the high speed mode corresponds to a second pressing stroke of said trigger, and a maximum value of the pressed depth of said trigger in the second pressing stroke is greater than a maximum value of the pressed depth of said trigger in the first pressing stroke.

8. The power tool as claimed in claim 7, wherein the first pressing stroke corresponds to the low-speed curve segment.

9. The power tool as claimed in claim 7, wherein the common control curve further has an intermediate segment between the low-speed curve segment and the high-speed curve segment, and in the high speed mode, said controller is configured to output the control signal to control the rotation speed of said motor based on the high-speed control curve that is composed of the low-speed curve segment, the intermediate segment, and the high-speed curve segment that are connected to each other in such sequence, and the high-speed control curve is identical to the common control curve.

10. The power tool as claimed in claim 9, wherein the intermediate segment of the common control curve corresponds to the reference rotation speed not greater than the predetermined low speed.

11. The power tool as claimed in claim 7, wherein the second pressing stroke corresponds to the high-speed control curve.

12. The power tool as claimed in claim 7, wherein the high-speed curve segment corresponds to the reference rotation speed greater than the predetermined low speed and not greater than a predetermined high speed, and in the high speed mode, said controller is configured to output the control signal to control the rotation speed of said motor to be not greater than the predetermined high speed,
wherein a value of the reference pressed depth corresponding to the predetermined high speed on an extending curve of the low-speed curve segment is less than a value of the reference pressed depth corresponding to the predetermined high speed on the high-speed curve segment.

13. The power tool as claimed in claim 12, wherein the low-speed curve segment is defined by a first exponential function having a first fixed base, and the high-speed curve segment is defined by a second exponential function that is different from the first exponential function and that has a second fixed base smaller than the first fixed base.

14. The power tool as claimed in claim 1, wherein the common control curve further has an intermediate segment between the low-speed curve segment and the high-speed curve segment, and in the high speed mode, said controller is configured to output the control signal to control the rotation speed of said motor based on the high-speed control curve that is composed of the low-speed curve segment, the intermediate segment, and the high-speed curve segment that are connected to each other in such sequence, and the high-speed control curve is identical to the common control curve.

15. The power tool as claimed in claim 14, wherein the intermediate segment of the common control curve corresponds to the reference rotation speed not greater than the predetermined low speed.

16. An operation method of the power tool of claim 1, comprising:
in the low speed mode,
in response to obtaining the pressing value not greater than the first value, the controller controlling the rotation speed of the motor based on the low-speed curve segment of the common control curve, and
in response to obtaining the pressing value greater than the first value, the controller controlling the rotation speed of the motor to be not greater than the predetermined low speed; and
in the high speed mode, the controller controlling the rotation speed of the motor based on the high-speed control curve composed at least of the low-speed curve segment and the high-speed curve segment.

17. The operation method as claimed in claim 16, the plurality of operating modes further including a medium speed mode,
wherein the common control curve further has a medium-speed segment that corresponds to the reference pressed depth ranging from the first value to a second value greater than the first value and to the reference rotation speed ranging from the predetermined low speed to a predetermined medium speed, the reference rotation speed is positively correlated to the reference pressed depth on the medium-speed curve segment, and the medium-speed curve segment has a slope that increases with an increase in the reference pressed depth,
wherein the operation method further comprises, in the medium speed mode,
in response to obtaining the pressing value not greater than the second value, the controller controlling the rotation speed of the motor based on a medium-speed control curve composed of the low-speed curve segment and the medium-speed curve segment, and
in response to obtaining the pressing value greater than the second value, the controller controlling the rotation speed of the motor not greater than the predetermined medium speed.

18. The operation method as claimed in claim 17, wherein the high-speed curve segment corresponds to the reference pressed depth greater than the second value and to the reference rotation speed greater than the predetermined medium speed,
wherein, in the high speed mode, controlling the rotation speed of the motor is to control the rotation speed of the motor based on the high-speed control curve composed of the low-speed curve segment, the medium-speed curve segment, and the high-speed curve segment.

19. The operation method as claimed in claim 16, wherein the common control curve further has an intermediate segment between the low-speed curve segment and the high-speed curve segment,
wherein in the high speed mode, controlling the rotation speed of the motor is to control the rotation speed of the motor based on the high-speed control curve composed of the low-speed curve segment, the intermediate segment, and the high-speed curve segment.

20. The operation method as claimed in claim 19, wherein the intermediate segment of the common control curve corresponds to the reference rotation speed not greater than the predetermined low speed.
